(19) United States
(12) Patent Application Publication
(10) Pub. No.: US 2008/0071985 A1
(43) Pub. Date: Mar. 20, 2008

(54) Disk array device, redundant array of inexpensive disks controller and disk array construction method of the disk array device

(75) Inventor: Yutaka Koike, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/889,820

(22) Filed: Aug. 16, 2007

(30) Foreign Application Priority Data
Sep. 14, 2006 (JP) 2006-249937

(51) Int. Cl. G06F 12/00

(52) U.S. Cl. 711/114; 711/E12.001

(57) ABSTRACT

According to one embodiment, a disk array device capable of utilizing redundant areas, which are a part of areas on disk devices constituting a disk array and are not incorporated into the disk array, as areas of stand-alone disk devices other than the disk array, includes a determining unit configured to determine whether or not the redundant areas are in use as the areas of the stand-alone disk devices, and a disk array construction unit configured to make the determining unit determines whether or not the redundant areas are in use as the areas of the stand-alone disk devices in installing the redundant areas to construct a new disk array, and to re-arrange data recorded in the redundant areas onto the new disk array, when it is determined that the redundant areas are in use as the areas of the stand-alone disk devices.

### CROSS-REFERENCE TO RELATED APPLICATIONS

This application is based upon and claims the benefit of priority from Japanese Patent Application No. 2006-249937, filed Sep. 14, 2006, the entire contents of which are incorporated herein by reference.

### BACKGROUND

1. Field

One embodiment of the invention relates to disk array construction technique capable of separately utilizing redundant areas existing on disk devices constituting a disk array.

2. Description of the Related Art

In recent years, the high functionality of portable, battery-operable notebook type personal computers has been progressed, which has enabled a more varied range of work styles both in an out of the office. Therefore, recently, demands for high-response and fault tolerance for a data storage device to be mounted on the personal computer have been growing.

As to a technique corresponding to this request, there exists a redundant array of inexpensive disks (RAID) function to connect a plurality of disk devices in parallel and to operate in cooperation therewith as one disk device. Therefore, even regarding notebook type personal computers, many of them have slots to add the second disk device thereto if necessary. Of cause, it is possible for the added second disk device to constitute a disk array together with the first disk device, and also the added second disk device itself is usable as the stand-alone of the second disk device.

Since the disk array is a data storage device of a special form, specialized knowledge is required to construct it. Therefore, a variety of recommendations of support methods to enable a general user who has no specialized knowledge to simply construct the disk array has been proposed (e.g., JP-A 2002-20245).

The disk array shows an upper system a plurality of disk devices as one disk device under control through a control device referred to as a RAID controller, however, some RAID controllers have functions of managing areas of respective disk devices constituting the disk array by dividing them into the areas to use as the disk array and areas of a stand-alone disk device other than the disk array. This function aims to effectively utilize redundant areas generated on the disk device larger in data storage capacity when, for instance, a data storage capacity of the first disk device is different from that of the second disk device.

A large number of RAID controllers enable one disk device be constituted in a plurality of disk arrays. For example, using two sets of disk devices of the same combination allows constructing two disk arrays that are a RAID-0 for striping and a RAID-1 for mirroring.

Here, a personal computer, which has a function to construct a disk array but mounts only one disk device at present, is discussed. It is presumed that a user intends to add the second disk from the first, and constructs the RAID-0 by using a half of the area of the one disk device, and starts to use another half of the area as a stand-alone disk device. At this time point, the one disk device is not effective as the RAID-0, however the user may utilize a data re-arrangement function of the RAID controller for adding a second disk device.

It is supposed that, in adding the second disk device, the user further intends to construct the RAID-1 by using redundant areas not installed into the RAID-0. In such a case, it is preferable to reflect the data, which has been used by the user as the area of the stand-alone disk device, to the constituted RAID-1.

However, up to now, for constructing a new disk array by incorporating such redundant areas, a procedure deleting once the redundant areas to release them, and newly incorporating the redundant areas into a new disk array has been used. That is, deleting the redundant areas has not secured the data which has been stored in the redundant areas.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view illustrating a configuration of an information processing apparatus to which a RAID concerned in an embodiment of the invention is applied;

FIG. 2 is an exemplary view illustrating a functional block diagram of a disk array device (refereed to as RAID) controller owned by the RAID of the embodiment;

FIG. 3 is an exemplary view for explaining a modified of a disk array configuration to be implemented on the RAID of the embodiment; and

FIG. 4 is an exemplary flowchart illustrating an operation procedure in which the RAID of the embodiment incorporates redundant areas to construct a new disk array.

### DETAILED DESCRIPTION

Various embodiments according to the invention will be described hereinafter with reference to the accompanying drawings. In general, according to one embodiment of the invention, a disk array device capable of utilizing redundant areas, which are a part of areas on disk devices constituting a disk array and are not incorporated into the disk array, as areas of stand-alone disk devices other than the disk array, includes a determining unit configured to determine whether or not the redundant areas are in use as the areas of the stand-alone disk devices, and a disk array construction unit configured to make the determining unit determines whether or not the redundant areas are in use as the areas of the stand-alone disk devices in installing the redundant areas to construct a new disk array, and to re-arrange data recorded in the redundant areas onto the new disk array, when it is determined that the redundant areas are in use as the areas of the stand-alone disk devices.

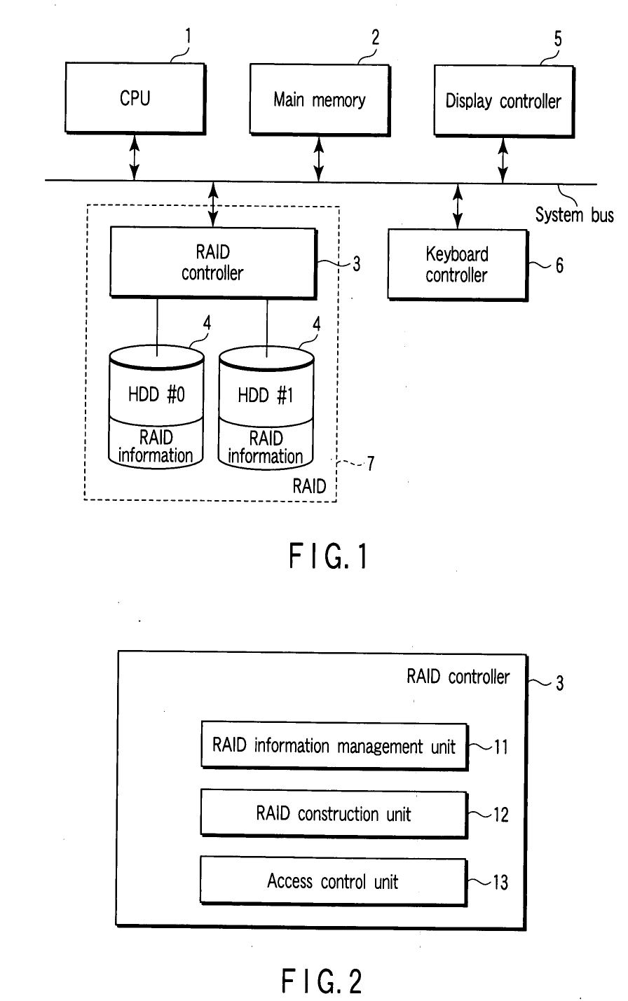

FIG. 1 shows an exemplary configuration of an information processing apparatus employing a disk array device (referred to as RAID) regarding the embodiment. The information processing apparatus is achieved, for example, as a notebook type personal computer, and as shown in FIG. 1, the processing apparatus comprises a CPU1, a main memory 2, a RAID controller 3, a plurality of disk devices (referred to as HDDs) 4, a display controller 5, a keyboard controller 6, etc. In the processing apparatus, a RAID 7 is constructed by the RAID controller 3 and the plurality of HDDs 4.

The CPU 1 is a processor to control operations of the processing apparatus, and carries out a variety of programs including an operating system and a utility which are loaded on the main memory 2 from the HDDs 4.

The main memory 2 is a memory device with a high speed and a small capacity to be used as a main memory of the processing apparatus. The plurality of HDDs 4 constituting the RAID 7 under the control by the RAID controller 3 are memory devices with lower speeds and larger capacities (in comparison with the main memory 2) to be used as external memories of the processing apparatus.

The display controller 5 is a device to bear an output side of a user interface to be provided by the processing apparatus, and displays the display data created by the CPU 1 onto, e.g., a liquid crystal display (LCD). On the other hand, the keyboard controller 6 is a device to bear an input side of the user interface to be provided by the processing apparatus, and to digitize operations of, e.g., a keyboard, a mouse, etc., by a user to transfer them to the CPU 1.

When creating a disk array, the RAID controller 3 stores types of the disk arrays (RAID-0, RAID-1, etc.) and disk array information (RAID information) indicating the HDD 4 used to construct the disk array into prescribed areas of each HDD 4. Usually, the RAID controller 3 secures last several sectors of each HDD 4 as prescribed areas to store the RAID information. For instance, if the RAID-0 is constructed by using two HDDs 4, i.e., an HDD #0 and an HDD #1, the RAID information indicating that the RAID-0 is constituted with the HDD #1 in a prescribed area of the HDD #0.

The RAID controller 3 may incorporate one HDD 4 into two disk arrays. When further constructing the RAID-1 by using two HDDs 4 of, e.g., the HDD #0 and the HDD #1, etc. (in addition to the RAID-0), information indicating that the RAID-1 is constructed with the HDD #1 is added into the RAID information to be stored in the prescribed area of the HDD #0.

To effectively utilize areas which belong to a part of areas of the HDDs 4 with a disk array constituted thereby (here, referred to as redundant areas), the information processing apparatus provides an interface to access the redundant areas as stand-alone disk devices other than the disk array. Therefore, the RAID controller 3 manages information indicating validity (to use as areas of stand-alone disk devices)/invalidity (not to use) of the redundant areas as the RAID information. For example, when constructing the RAID-0 by using two HDDs 4 of the HDD #0 and the HDD #1, and if the redundant areas of the HDD #0 are valid and those of the HDD #1 are invalid, an upper system to be executed by the CPU 1 results in seeming of existence of two HDDs (disk array, stand-alone disk device).

The disk array device (RAID) of the embodiment of the invention enables constructing a new disk array by incorporating the redundant areas while securing the data stored in the redundant areas being in effective use, and such a point will be described in detail below.

FIG. 2 shows an exemplary functional block of the RAID controller 3. As shown, the RAID controller 3 includes a RAID information management unit 11, a RAID construction unit 12 and an access control unit 13.

The management unit 11 records the RAID information onto each HDD 4 to be constituent components when the disk array is constructed, and updates the information when the configuration of the disk array is changed. The management unit 11 also records information, indicating validity/invalidity of redundant areas of each HDD 4 constructing the disk array, as the RAID information.

The constructing unit 12 cooperates with an expansion basic input/output system (BIOS) for a RAID to carry out an establishment of the disk array, a change in configuration thereof, and data re-arrangement for replacement of a faulty HDD 4, etc. The control unit 13, for instance, when the RAID-0 consists of the HDD #0 and the HDD #1, carries out input/output control to distribute write-data to two of the HDDs 4 for write it in parallel, and to read out the read-data from two of the HDDs 4 in parallel. The control unit 13 executes and controls the write in/read out to/from valid redundant areas as a stand-alone disk device other than the disk array.

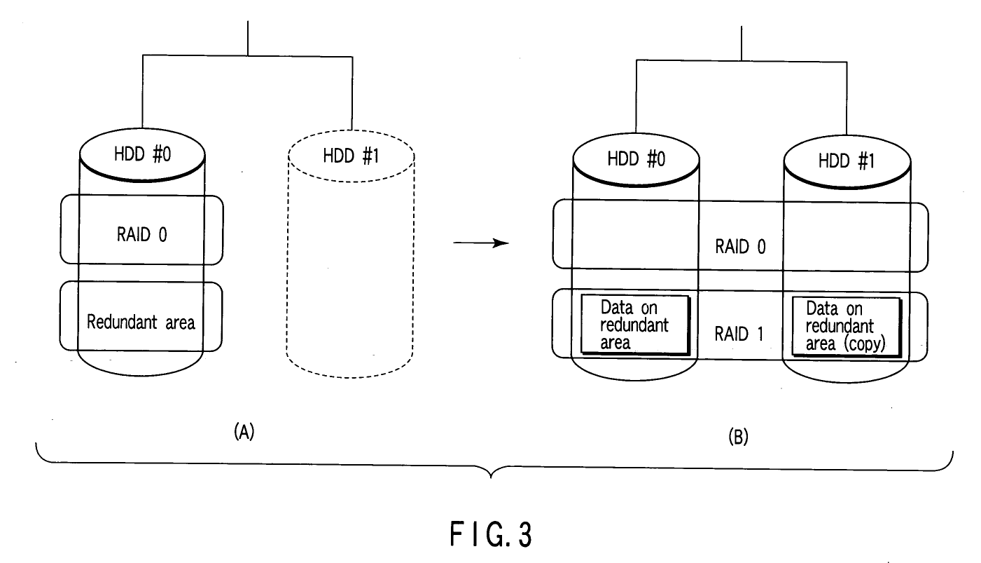

As depicted in FIG. 3, the case is taken into account in which the system configuration of the information processing apparatus is changed from (A) a state that only one HDD 4 of the HDD #0 is mounted to (B) a state that the HDD 4 of the HDD #1 is added to result in the mounting of two HDDs 4. It is presumed that the RAID-0 is constructed in the existing HDD 4 of the HDD #0, and that there exists the redundant areas to be set effective. To add the HDD 4 of the HDD #1, the HDD #1 is installed into the already constructed RAID-0, and also the RAID-1 is newly constructed by the HDDs #0 and #1 by using the redundant areas of the HDD #0 being in effective use.

The RAID controller 3 that received this instruction firstly changes in configuration to incorporate the HDD 4 of the added HDD #1 into the RAID-0 already constructed. The RAID construction unit 12 records the information indicating the configuration change content as the RAID information.

The RAID controller 3 secondly operates to construct the RAID-1 between the redundant areas of the HDD #0 and the redundant areas of the HDD #1 which have been generated by incorporating into the RAID-0. The construction unit 12 firstly secures an area corresponding to the redundant areas of the HDD #0 onto the HDD #1. Next, the construction unit 12 refers to the RAID information of the HDD #0 to check the validity of the redundant areas of the HDD #0. If it is valid, the construction unit 12 records the information indicating the content to change the redundant areas of the HDD #0 into the RAID-1 from a stand-alone disk device (to and from HDD #1). If the redundant areas of the HDD #0 are set invalid, the construction unit 12 records the information informing of the new construction of the RAID-1 from the HDDs #0 and #1 as the RAID information.

After the construction unit 12 records such RAID information, when the system is shut down and re-booted again, an expansion BIOS for RAID carries out re-arrangement of data so as to conduct striping the data, which has been recorded only on the HDD #0, on the RAID-0 to the HDDs #0 and #1. The RAID-1 is newly constructed while copying the data recorded in the redundant areas on the HDD #0 to the HDD #1. With this execution, the RAID information management unit 11 performs rewriting the RAID information on the HDD #0, and writing the RAID information on the HDD #1.

In other words, for newly constructing a disk array by incorporating the redundant areas of the existing HDD 4, the disk array device in the embodiment does not carry out processing to delete and release the redundant areas uniformly, but when the RAID information informs that the redundant areas are in effective use, the device achieves a construction of a new disk array while securing the data recorded in the redundant areas.

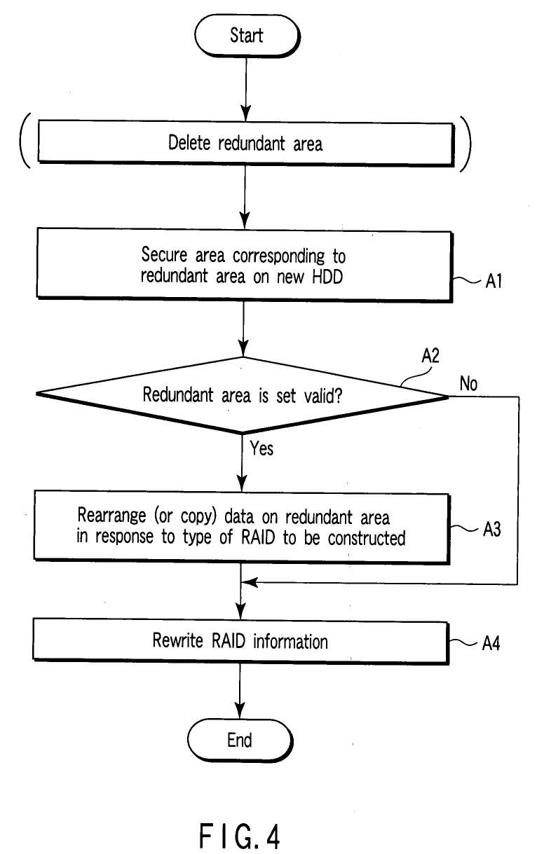

FIG. 4 is an exemplary flowchart showing an operation procedure in the case when the disk array device of the embodiment constructs a new disk array by incorporating redundant areas.

For incorporating the redundant areas to construct the new disk array, in the disk array device of the embodiment, at first, the RAID construction unit 12 secures the areas corresponding to the redundant areas of the existing HDD 4 on the new HDD 4 without deleting the redundant areas (block A1). The RAID construction unit 12, in succession, refers to the RAID information of the existing HDD 4 to check whether or not the redundant areas are valid (block A2), and if they are valid (YES, in block A2), the construction unit 12 implements processing in order to re-arrange the data recorded in the redundant areas of the existing HDD 4, such as recording of the RAID information, in response to the types of the disk array to be constructed (block A3).

With the construction of the new disk array, the RAID information management unit 11 then rewrites each piece of RAID information in the existing HDD 4 and the new HDD 4 (block A4).

As mentioned above, the disk array device regarding the embodiment of the invention enables installing the redundant areas into the device and constructing the new disk array while securing the data in the redundant areas which have not been installed into the disk array.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A disk array device capable of utilizing redundant areas, which are a part of areas on disk devices constituting a disk array and are not incorporated into the disk array, as areas of stand-alone disk devices other than the disk array, comprising:
a determining unit configured to determine whether or not the redundant areas are in use as the areas of the stand-alone disk devices; and
a disk array construction unit configured to make the determining unit determines whether or not the redundant areas are in use as the areas of the stand-alone disk devices in installing the redundant areas to construct a new disk array, and to re-arrange data recorded in the redundant areas onto the new disk array, when it is determined that the redundant areas are in use as the areas of the stand-alone disk devices.

2. The disk array device according to claim 1, wherein the determining unit refers to disk array information being stored on each disk device and indicating a construction situation of a disk array to determine whether or not the redundant areas are in use as the areas of the stand-alone disk device.

3. The disk array device according to claim 1, wherein the disk array construction unit copies the data recorded in the redundant areas into the corresponding areas on other disk devices when the new disk array is a redundant array of inexpensive disks (RAID)-1.

4. A redundant array of inexpensive disks (RAID) controller constituting RAID by using a plurality of disk devices connected in parallel with one another, comprising:
a management unit configured to manage redundant areas which are a part of areas on the disk devices constituting the RAID and have not been installed into the RAID so as to be used as areas of stand-alone disk devices other than the RAID; and
a RAID constitution unit configured to re-arrange data recorded in redundant areas onto a new RAID when the redundant areas are managed as areas of stand-alone disk devices in installing the redundant areas to construct the RAID.

5. The RAID controller according to claim 4, wherein the management unit manages information indicating whether or not the redundant areas are used as areas of the stand-alone disk devices, as RAID information to store on each disk device constituting the RAID and to show a construction situation of the RAID.

6. The RAID controller according to claim 4, wherein the disk array construction unit copies data recorded in the redundant areas into the corresponding areas on other disk devices when the new RAID is a RAID-1.

7. A disk array construction method of a disk array device capable of utilizing redundant areas, which are a part of areas of disk devices constituting a disk array and which have not been installed into the disk array, as areas of stand-alone disk devices other than the disk array, comprising:
determining whether or not the redundant areas are in use as areas of stand-alone disk devices in installing the redundant areas to construct a new disk; and
re-arranging data recorded on the redundant areas onto the new disk array when it is determined that the redundant areas are used as the areas of the stand-alone disk devices.

8. The method according to claim 7, further including referring to disk array information which is stored on each disk device and shows a construction situation of a disk array to determine whether or not the redundant areas are in use as the areas of the stand-alone disk device.

9. The method according to claim 7, further including copying the data recorded in the redundant areas into the corresponding areas on other disk devices when the new disk array is a RAID-1.
